(19) United States
(12) Patent Application Publication
(10) Pub. No.: US 2025/0252112 A1
(43) Pub. Date: Aug. 7, 2025

(54) MULTI-PHASE TRAINING OF MACHINE LEARNING MODELS FOR SEARCH RESULTS RANKING

(71) Applicant: Y.E. Hub Armenia LLC, Yerevan (AM)

(72) Inventors: Vsevolod Aleksandrovich SVETLOV, Moscow (RU); Kirill Yaroslavovich KHRYLCHENKO, Moscow (RU)

(21) Appl. No.: 19/191,253

(22) Filed: Apr. 28, 2025

Related U.S. Application Data
(63) Continuation of application No. 17/831,473, filed on Jun. 3, 2022.

(30) Foreign Application Priority Data
Nov. 22, 2021 (RU) 2021133942

(51) Int. Cl. G06F 16/2457; G06N 20/00

(52) U.S. Cl. CPC G06F 16/24578; G06N 20/00

(57) ABSTRACT

A method and system for training a machine-learning algorithm (MLA) to rank digital documents at an online search platform. The method comprises training the MLA in a first phase for determining past user interactions of a given user with past digital documents based on a first set of training objects including the past digital documents generated by the online search platform in response to the given user having submitted thereto respective past queries. The method further comprises training the MLA in a second phase to determine respective likelihood values of the given user interacting with in-use digital documents based on a second set of training objects including only those past digital documents with which the given user has interacted and respective past queries associated therewith. The MLA may include a Transformer-based learning model, such as a BERT model.

### CROSS-REFERENCE

The present application is a continuation of U.S. patent application Ser. No. 17/831,473, filed on Jun. 3, 2022, entitled “MULTI-PHASE TRAINING OF MACHINE LEARNING MODELS FOR SEARCH RESULTS RANKING,” which claims priority to Russian Patent Application No. 2021133942, filed Nov. 22, 2021, the entirety of each of which is incorporated by reference herein.

### FIELD OF TECHNOLOGY

The present technology relates to machine learning methods, and more specifically, to methods and systems for training and using transformer-based machine learning models for ranking search results.

### BACKGROUND

Web search is an important problem, with billions of user queries processed daily. Current web search systems typically rank search results according to their relevance to the search query, as well as other criteria. To determine the relevance of search results to a query often involves the use of machine learning algorithms that have been trained using multiple hand-crafted features to estimate various measures of relevance. This relevance determination can be seen as, at least in part, as a language comprehension problem, since the relevance of a document to a search query will have at least some relation to a semantic understanding of both the query and of the search results, even in instances in which the query and results share no common words, or in which the results are images, music, or other non-text results.

Recent developments in neural natural language processing include use of “transformer” machine learning models, as described in Vaswani et al., “Attention Is All You Need,” Advances in neural information processing systems, pages 5998-6008, 2017. A transformer is a deep learning model (i.e. an artificial neural network or other machine learning model having multiple layers) that uses an “attention” mechanism to assign greater significance to some portions of the input than to others. In natural language processing, this attention mechanism is used to provide context to the words in the input, so the same word in different contexts may have different meanings. Transformers are also capable of processing numerous words or natural language tokens in parallel, permitting use of parallelism in training.

Transformers have served as the basis for other advances in natural language processing, including pretrained systems, which may be pretrained using a large dataset, and then “refined” for use in specific applications. Examples of such systems include BERT (Bidirectional Encoder Representations from Transformers), as described in Devlin et al., “BERT: Pre-training of Deep Bidirectional Transformers for Language Understanding,” Proceedings of NAACL-HLT 2019, pages 4171-4186, 2019, and GPT (Generative Pre-trained Transformer), as described in Radford et al., “Improving Language Understanding by Generative Pre-Training,” 2018.

While transformers have had substantial success in natural language processing tasks, there may be some practical difficulties in using them for search ranking. For example, many large search relevance datasets include non-text data, such as information on which links have been clicked by users, which may be useful in training a ranking model.

### SUMMARY

Certain non-limiting embodiments of the present technology are directed to methods and systems for training a transformer-based learning model to determine relevance parameters of search results provided by an online search platform (such as a search engine, as an example) to a given user. For example, in at least some non-limiting embodiments of the present technology, such relevance parameters may be represented by likelihood values of user interaction (such as a click or a long click) of the given user with the search results; and the transformer-based learning model may thus be trained based on specifically organized training data.

More specifically, developers of the present technology have appreciated that quality of ranking the search results can be improved if the transformer-based learning model is trained in two phases. In a first phase, which is also referred to herein as “a pre-training phase”, the training data is organized in a first training set of data including at least a subset of past search results and respective past search queries, however, not including any indications of whether the given user has ever interacted therewith. Thus, in the first phase of training, based on the first training set of data, the transformer-based learning model is trained to predict if the given user has interacted with each of the past search results.

In a second phase of training, the training data is organized in a second training set of data including only past search results with which the user has interacted and their respective past search queries. The so generated second training set of data is further used for training the transformer-based learning model to predict if the user will interact with a given in-use search result provided thereto in response to submitting a respective in-use search query.

Thus, during the first phase of training, the present methods and systems are directed to providing the transformer-based learning model with more tokens, on which the learning model is trained to generate the prediction, which results in determining preliminary weights for layers of the transformer-based learning model. These weights can further be finetuned during the second phase of training when the transformer-based learning model is trained based only on those past search results that include indications of positive past user interactions therewith.

By doing so, the methods and systems described herein allow for training the transformer-based learning model to rank the search results in a more efficient fashion using limited amount of training data. In some non-limiting embodiments of the present technology, the quality of prediction of relevancy of a search result for a specific user is improved, i.e. resulting in an improved personalized ranking.

In accordance with a first broad aspect of the present technology, there is provided a computer-implemented method for training a machine-learning algorithm (MLA) to rank in-use digital documents at an online search platform. The method is executable by a processor. The method comprises: receiving, by the processor, training data associated with a given user, the training data including (i) a plurality of past queries having been submitted by the given user to the online search platform; (ii) respective sets of past digital documents generated, by the online search platform, in response to submitting thereto each one of the plurality of past queries, and a given past digital document including a respective past user interaction parameter indicative of whether the given user has interacted with the given past digital document. During a first training phase, the method comprises: organizing, by the processor, the training data in a first set of training digital objects, a given training digital object of the first set of training digital objects including: (i) a respective past query from the plurality of past queries; and (ii) a predetermined number of past digital documents responsive to the respective past query; and training, by the processor, based on the first set of training digital objects, the MLA for determining, for the given training digital object of the first set of training digital objects, if the given user has interacted with each one of the predetermined number of past digital documents. Further, during a second training phase, following the first training phase, the method comprises: organizing, by the processor, the training data in a second set of training digital objects, a given training digital object of the second set of training digital including: (i) the respective past query from the plurality of past queries; and (ii) a number of past digital documents responsive to the respective training with which the given user has interacted; and training, by the processor, based on the second set of training digital objects, the MLA to determine, for a given in-use digital document, a likelihood parameter of the given user interacting with the given in-use digital document.

In some implementations of the method, the past digital documents associated with the given training digital objects of the first set of training digital objects have been randomly selected from a respective set of digital documents responsive to the respective past query.

In some implementations of the method, the respective past user interaction parameter associated with the given past digital document has been determined based on past click data of the given user.

In some implementations of the method, the click data includes data of at least one click of the given user on the given past digital document made in response to submitting the respective past query to the online search platform.

In some implementations of the method, the method further comprises: receiving, by the processor, an in-use query; retrieving, by the processor, a set of in-use digital documents responsive to the in-use query; applying, by the processor, the MLA to each one of the set of in-use digital documents to generate respective likelihood parameters of the given user interacting therewith; and using, by the processor, the respective likelihood parameters for ranking each one of the set of in-use digital documents.

In some implementations of the method, the using the respective likelihood parameters comprises feeding the respective likelihood parameters as an input to an other MLA, the other MLA having been configured to rank the set of in-use digital documents based at least on the respective likelihood values of the given user interacting therewith.

In some implementations of the method, the other MLA is an ensemble of CatBoost decision trees.

In some implementations of the method, the number of past digital documents responsive to the respective past query with which the given user has interacted are all the past digital documents in a respective set of digital documents responsive to the respective past query that the user has interacted with.

In some implementations of the method, a first total number of members in the first set of training digital objects and a second total number of members in the second set of training digital objects are the same.

In some implementations of the method, a first total number of members in the first set of training digital objects and a second total number of members in the second set of training digital objects are pre-determined.

In some implementations of the method, the MLA is a Transformer-based MLA.

In accordance with a second broad aspect of the present technology, there is provided a system for training a machine-learning algorithm (MLA) to rank in-use digital documents at an online search platform. The system comprises a processor and non-transitory computer readable medium storing instructions. The processor, upon executing the instructions, is configured to: receive training data associated with a given user, the training data including (i) a plurality of past queries having been submitted by the given user to the online search platform; (ii) respective sets of past digital documents generated, by the online search platform, in response to submitting thereto each one of the plurality of past queries, and a given past digital document including a respective past user interaction parameter indicative of whether the given user has interacted with the given past digital document. During a first training phase, the processor is configured to: organize the training data in a first set of training digital objects, a given training digital object of the first set of training digital objects including: (i) a respective past query from the plurality of past queries; and (ii) a predetermined number of past digital documents responsive to the respective past query; and train, based on the first set of training digital objects, the MLA for determining, for the given training digital object of the first set of training digital objects, if the given user has interacted with each one of the predetermined number of past digital documents. Further, during a second training phase, following the first training phase, the processor is configured to: organize the training data in a second set of training digital objects, a given training digital object of the second set of training digital including: (i) the respective past query from the plurality of past queries; and (ii) a number of past digital documents responsive to the respective training with which the given user has interacted; and train, based on the second set of training digital objects, the MLA to determine, for a given in-use digital document, a likelihood parameter of the given user interacting with the given in-use digital document.

In some implementations of the system, the processor is configured to select the past digital documents associated with the given training digital objects of the first set of training digital objects from a respective set of digital documents responsive to the respective past query randomly.

In some implementations of the system, the processor is further configured to determine the respective past user interaction parameter associated with the given past digital document based on past click data of the given user.

In some implementations of the system, the click data includes data of at least one click of the given user on the given past digital document made in response to submitting the respective past query to the online search platform.

In some implementations of the system, the processor is further configured to: receive an in-use query; retrieve a set of in-use digital documents responsive to the in-use query; apply the MLA to each one of the set of in-use digital documents to generate respective likelihood parameters of the given user interacting therewith; and use the respective likelihood parameters for ranking each one of the set of in-use digital documents.

In some implementations of the system, to use the respective likelihood parameters, the processor is further configured to feed the respective likelihood parameters as an input to an other MLA, the other MLA having been configured to rank the set of in-use digital documents based at least on the respective likelihood values of the given user interacting therewith.

In some implementations of the system, the other MLA is an ensemble of CatBoost decision trees.

In some implementations of the system, the number of past digital documents responsive to the respective past query with which the given user has interacted are all the past digital documents in a respective set of digital documents responsive to the respective past query that the user has interacted with.

In some implementations of the system, a first total number of members in the first set of training digital objects and a second total number of members in the second set of training digital objects are the same.

In some implementations of the system, a first total number of members in the first set of training digital objects and a second total number of members in the second set of training digital objects are pre-determined.

In some implementations of the system, the MLA is a Transformer-based MLA.

In the context of the present specification, a “server” is a computer program that is running on appropriate hardware and is capable of receiving requests (e.g., from client devices) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g., received instructions or requests) or any particular task will have been received, carried out, or caused to be carried out, by the same server (i.e., the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” is any computer hardware that is capable of running software appropriate to the relevant task at hand. Thus, some (non-limiting) examples of client devices include personal computers (desktops, laptops, netbooks, etc.), smartphones, and tablets, as well as network equipment such as routers, switches, and gateways. It should be noted that a device acting as a client device in the present context is not precluded from acting as a server to other client devices. The use of the expression “a client device” does not preclude multiple client devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus, information includes, but is not limited to audiovisual works (images, movies, sound records, presentations, etc.), data (location data, numerical data, etc.), text (opinions, comments, questions, messages, etc.), documents, spreadsheets, lists of words, etc.

In the context of the present specification, the expression “component” is meant to include software (appropriate to a particular hardware context) that is both necessary and sufficient to achieve the specific function(s) being referenced.

In the context of the present specification, the expression “computer usable information storage medium” is intended to include media of any nature and kind whatsoever, including RAM, ROM, disks (CD-ROMs, DVDs, floppy disks, hard drivers, etc.), USB keys, solid state-drives, tape drives, etc.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

These and other features, aspects and advantages of the present technology will become better understood with regard to the following description, appended claims and accompanying drawings where:

FIG. 1 depicts a schematic diagram of an example computer system for implementing certain non-limiting embodiments of systems and/or methods of the present technology;

FIG. 2 depicts a networked computing environment suitable for training a machine learning model to determine likelihood values of a given user interacting with digital documents generated by an online search platform, in accordance with certain non-limiting embodiments of the present technology;

FIG. 3 depicts a block diagram of a machine learning model architecture run by a server present in the networked computing environment of FIG. 2, in accordance with certain non-limiting embodiments of the present technology;

FIG. 4 depicts a schematic diagram of a process for organizing, by the server present in the networked computing environment of FIG. 2, training data for training the machine learning model of FIG. 3, during a first phase of the training of the machine learning model, in accordance with certain non-limiting embodiments of the present technology;

FIG. 5 depicts a schematic diagram of a process for organizing, by the server present in the networked computing environment of FIG. 2, training data for training the machine learning model of FIG. 3 during a second phase of the training the machine learning model in accordance with certain non-limiting embodiments of the present technology; and

FIG. 6 depicts a flowchart diagram of a method of training the machine learning model of FIG. 3 to determine the likelihood values of the given user interacting with the digital documents, in accordance with certain non-limiting embodiments of the present technology.

### DETAILED DESCRIPTION

The examples and conditional language recited herein are principally intended to aid the reader in understanding the principles of the present technology and not to limit its scope to such specifically recited examples and conditions. It will be appreciated that those skilled in the art may devise various arrangements which, although not explicitly described or shown herein, nonetheless embody the principles of the present technology and are included within its spirit and scope.

Furthermore, as an aid to understanding, the following description may describe relatively simplified implementations of the present technology. As persons skilled in the art would understand, various implementations of the present technology may be of a greater complexity.

In some cases, what are believed to be helpful examples of modifications to the present technology may also be set forth. This is done merely as an aid to understanding, and, again, not to define the scope or set forth the bounds of the present technology. These modifications are not an exhaustive list, and a person skilled in the art may make other modifications while nonetheless remaining within the scope of the present technology. Further, where no examples of modifications have been set forth, it should not be interpreted that no modifications are possible and/or that what is described is the sole manner of implementing that element of the present technology.

Moreover, all statements herein reciting principles, aspects, and implementations of the present technology, as well as specific examples thereof, are intended to encompass both structural and functional equivalents thereof, whether they are currently known or developed in the future. Thus, for example, it will be appreciated by those skilled in the art that any block diagrams herein represent conceptual views of illustrative circuitry embodying the principles of the present technology. Similarly, it will be appreciated that any flowcharts, flow diagrams, state transition diagrams, pseudo-code, and the like represent various processes which may be substantially represented in computer-readable media and so executed by a computer or processor, whether or not such computer or processor is explicitly shown.

The functions of the various elements shown in the figures, including any functional block labeled as a “processor” or a “graphics processing unit,” may be provided through the use of dedicated hardware as well as hardware capable of executing software in association with appropriate software. When provided by a processor, the functions may be provided by a single dedicated processor, by a single shared processor, and/or by a plurality of individual processors, some of which may be shared. In some embodiments of the present technology, the processor may be a general-purpose processor, such as a central processing unit (CPU) or a processor dedicated to a specific purpose, such as a graphics processing unit (GPU). Moreover, explicit use of the term “processor” or “controller” should not be construed to refer exclusively to hardware capable of executing software, and may implicitly include, without limitation, digital signal processor (DSP) hardware, network processor, application specific integrated circuit (A SIC), field programmable gate array (FPGA), read-only memory (ROM) for storing software, random-access memory (RAM), and/or non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

With these fundamentals in place, we will now consider some non-limiting examples to illustrate various implementations of aspects of the present technology.

### Computer System

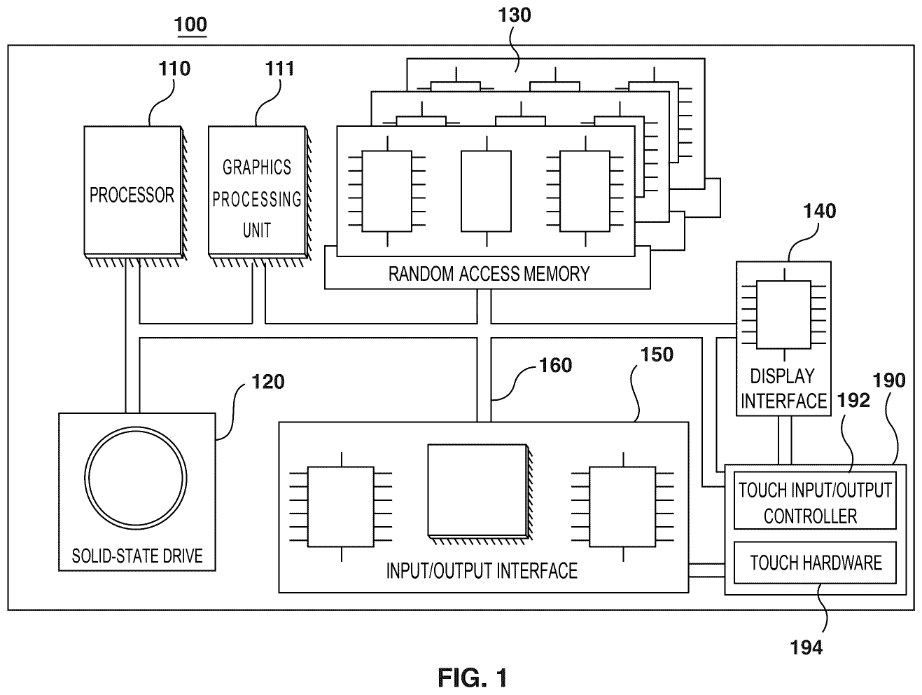

With reference to FIG. 1, there is depicted a computer system 100 suitable for use with some implementations of the present technology. The computer system 100 comprises various hardware components including one or more single or multi-core processors collectively represented by a processor 110, a graphics processing unit (GPU) 111, a solid-state drive 120, a random-access memory 130, a display interface 140, and an input/output interface 150.

Communication between the various components of the computer system 100 may be enabled by one or more internal and/or external buses 160 (e.g. a PCI bus, universal serial bus, IEEE 1394 “Firewire” bus, SCSI bus, Serial-ATA bus, etc.), to which the various hardware components are electronically coupled.

The input/output interface 150 may be coupled to a touchscreen 190 and/or to the one or more internal and/or external buses 160. The touchscreen 190 may be part of the display. In some non-limiting embodiments of the present technology, the touchscreen 190 is the display. The touchscreen 190 may equally be referred to as a screen 190. In the embodiments illustrated in FIG. 1, the touchscreen 190 comprises touch hardware 194 (e.g., pressure-sensitive cells embedded in a layer of a display allowing detection of a physical interaction between a user and the display) and a touch input/output controller 192 allowing communication with the display interface 140 and/or the one or more internal and/or external buses 160. In some embodiments, the input/output interface 150 may be connected to a keyboard (not shown), a mouse (not shown) or a trackpad (not shown) allowing the user to interact with the computer system 100 in addition to or instead of the touchscreen 190.

It is noted that some components of the computer system 100 can be omitted in some non-limiting embodiments of the present technology. For example, the touchscreen 190 can be omitted, especially (but not limited to) where the computer system is implemented as a server.

According to implementations of the present technology, the solid-state drive 120 stores program instructions suitable for being loaded into the random-access memory 130 and executed by the processor 110 and/or the GPU 111. For example, the program instructions may be part of a library or an application.

### Networked Computing Environment

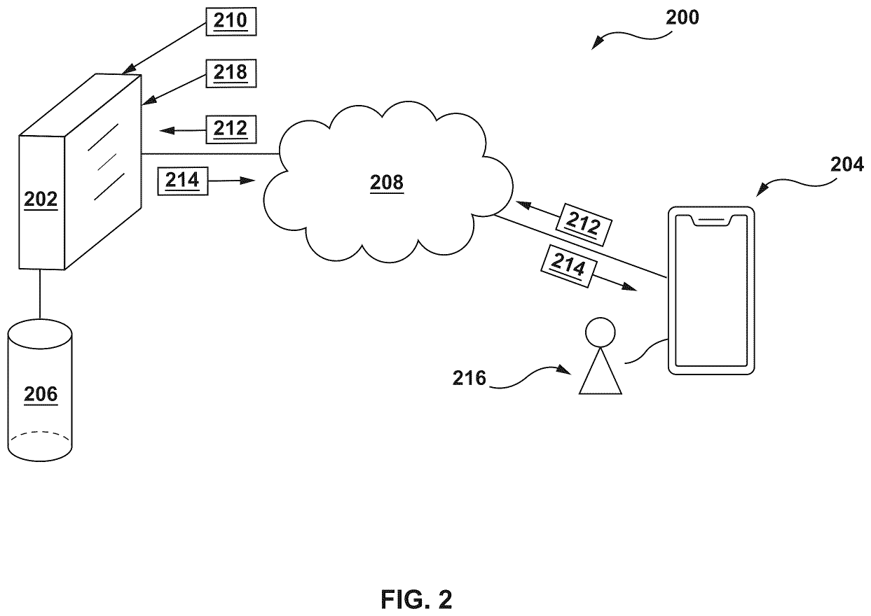

With reference to FIG. 2, there is depicted a schematic diagram of a networked computing environment 200 suitable for use with some non-limiting embodiments of the systems and/or methods of the present technology. The networked computing environment 200 comprises a server 202 communicatively coupled, via a communication network 208, to an electronic device 204. In the non-limiting embodiments of the present technology, the electronic device 204 may be associated with a user 216.

In some non-limiting embodiments of the present technology, the electronic device 204 may be any computer hardware that is capable of running a software appropriate to the relevant task at hand. Thus, some non-limiting examples of the electronic device 204 may include personal computers (desktops, laptops, netbooks, etc.), smartphones, and tablets. It should be expressly understood that, in some non-limiting embodiments of the present technology, the electronic device 204 may not be the only electronic device associated with the user 216; and the user 216 may rather be associated with other electronic devices (not depicted in FIG. 2) having access to the online search platform 210 via the communication network 208 without departing from the scope of the present technology.

In some non-limiting embodiments of the present technology, the server 202 is implemented as a conventional computer server and may comprise some or all of the components of the computer system 100 of FIG. 1. In a specific non-limiting example, the server 202 is implemented as a Dell™ PowerEdge™ Server running the Microsoft™ Windows Server™ operating system, but can also be implemented in any other suitable hardware, software, and/or firmware, or a combination thereof. In the depicted non-limiting embodiments of the present technology, the server 202 is a single server. In alternative non-limiting embodiments of the present technology (not depicted), the functionality of the server 202 may be distributed and may be implemented via multiple servers.

In some non-limiting embodiments of the present technology, the server 202 can be configured to host an online search platform 210. Broadly speaking, the online search platform 210 denotes a web software system configured for conducting searches in response to submitting search queries thereto. Types of search results the online search platform 210 can be configured to provide in response to the search queries generally depend on a particular implementation of the online search platform 210. For example, in some non-limiting embodiments of the present technology, the online search platform 210 can be implemented as a search engine (such as a Google™ search engine, a Yandex™ search engine, and the like), and the search results may include digital documents of various types, such as, without limitation, audio digital documents (songs, voice recordings, podcasts, as an example), video digital documents (video clips, films, cartoons, as an example), text digital documents, and the like. Further, in some non-limiting embodiments of the present technology, the online search platform 210 may be implemented as an online listing platform (such as a Yandex™ Market™ online listing platform), and the search results may include digital documents including advertisements of various items, such as goods and services. Other implementations of the online search platform 210 are also envisioned.

Therefore, in some non-limiting embodiments of the present technology, the server 202 can be communicatively coupled to a search database 206 configured to store information of digital documents potentially accessible via the communication network 208, for example, by the electronic device 204. To that end, the search database 206 could be preliminarily populated with indications of the digital documents, for example, via the process known as “crawling”, which, for example, can be implemented, in some non-limiting embodiments of the present technology, also by the server 202. In additional non-limiting embodiments of the present technology, the server 202 can be configured to store, in the search database 206, data indicative of every search conducted by the user 216 on the online search platform 210, and more specifically, search queries and respective sets of digital documents responsive thereto as well as their metadata, as an example.

Further, although in the embodiments depicted in FIG. 2, the search database 206 is depicted as a single entity, it should be expressly understood that in other non-limiting embodiments of the present technology, the functionality of the search database 206 could be distributed among several databases. Also, in some non-limiting embodiments of the present technology, the search database 206 could be accessed by the server 202 via the communication network 208, and not via a direct communication link (not separately labelled) as depicted in FIG. 2.

Thus, the user 216, using the electronic device 204, may submit a given query 212 to the online search platform 210, and the online search platform 210 can be configured to identify, in the search database 206, a set of digital documents 214 responsive to the given query 212. Further, to aid the user 216 in navigating through the set of digital documents 214, digital documents therein may need to be ranked, for example, according to their respective degrees of relevance to the given query 212.

In some non-limiting embodiments of the present technology, such degrees of relevance of each one of the set of digital documents 214 to the given user 216 may be represented by respective likelihood values of the given user 216 interacting with each one of the set of digital documents 214. For example, according to some non-limiting embodiments of the present technology, interacting with a given digital document may include at least one of: (i) the user 216 making at least one click on the given digital document, (ii) the user 216 making a long click on the given digital document, such as when the user 216 remains in the given digital document from a predetermined period (for example, 120 seconds); (iii) the user 216 dwelling on the given digital document within the set of digital document 214 for a predetermined period; and the like. It should be expressly understood that other types of user interactions of the given user 216 with digital documents are also envisioned without departing from the scope of the present technology.

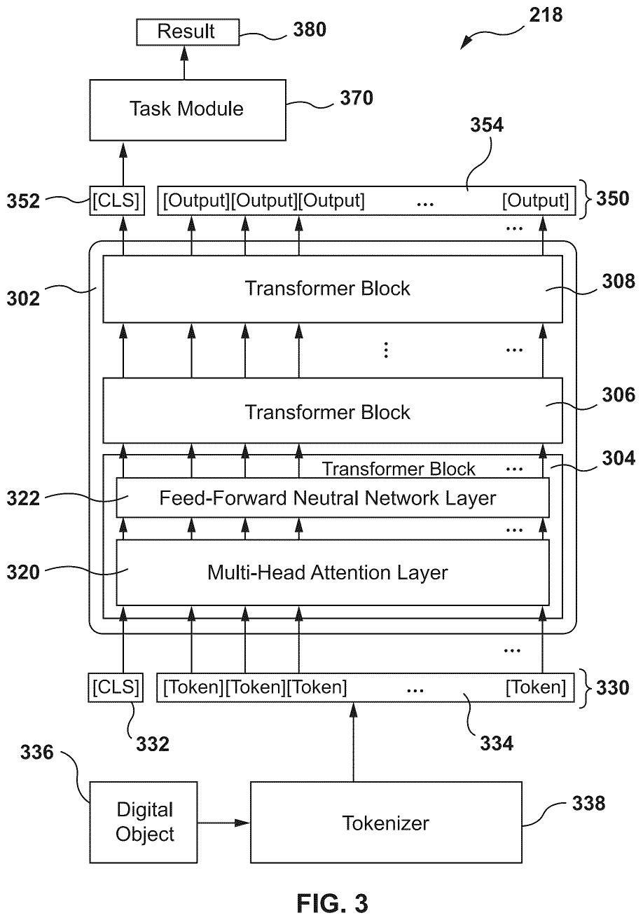

In some non-limiting embodiments of the present technology, to determine the respective likelihood values for each one of the set of digital documents 214, the server 202 can be configured to train and further apply a machine-learning algorithm (MLA) 218. Generally speaking, the server 202 can be said to be executing two respective processes in respect of the MLA 218. A first process of the two processes is a training process, where the server 202 is configured to train the MLA 218, based on a training set of data, to determine the respective likelihood values of the user 216 interacting with digital documents in the set of digital documents 214, which will be discussed below with reference to FIGS. 3 to 5. A second process is an in-use process, where the server 202 executes the so-trained MLA 218 for respective likelihood values, which will be described further below, in accordance with certain non-limiting embodiments of the present technology.

Developers of the present technology have appreciated that determining the respective likelihood values for each of the set of digital documents 214 may be more efficient and/or accurate if the MLA 218 is trained akin to natural language processing MLA s configured to determine missing tokens (such as words, phonemes, syllables, and the like) in a text based on a context provided by neighboring tokens therein. Thus, in some non-limiting embodiments of the present technology, the MLA 218 could be implemented as a Transformer-based MLA, such as a BERT MLA, architecture of which as well as generating the training set of data therefor will be described, in accordance with certain non-limiting embodiments of the present technology, below with reference to FIGS. 3 to 5.

### Communication Network

In some non-limiting embodiments of the present technology, the communication network 208 is the Internet. In alternative non-limiting embodiments of the present technology, the communication network 208 can be implemented as any suitable local area network (LAN), wide area network (WAN), a private communication network or the like. It should be expressly understood that implementations for the communication network are for illustration purposes only. How a respective communication link (not separately numbered) between each one of the server 202 and the electronic device 204 and the communication network 208 is implemented will depend, inter alia, on how each one of the server 202 and the electronic device 204 is implemented. Merely as an example and not as a limitation, in those embodiments of the present technology where the electronic device 204 is implemented as a wireless communication device such as a smartphone, the communication link can be implemented as a wireless communication link. Examples of wireless communication links include, but are not limited to, a 3G communication network link, a 4G communication network link, and the like. The communication network 208 may also use a wireless connection with the server 202.

### Machine Learning Model Architecture

With reference to FIG. 3, there is depicted a block diagram of an architecture of the MLA 218, in accordance with certain non-limiting embodiments of the present technology. As noted above, in some non-limiting embodiments of the present technology, the MLA 218 can be based on the BERT machine learning model, as described, for example, in the Devlin et al. paper referenced above. Like BERT, the MLA 218 includes a transformer stack 302 of transformer blocks, including, for example, transformer blocks 304, 306, and 308.

Each of the transformer blocks 304, 306, and 308 includes a transformer encoder block, as described, for example, in the Vaswani et al. paper, referenced above. Each of the transformer blocks 304, 306, and 308 includes a multi-head attention layer 320 (shown only in the transformer block 304 here, for purposes of illustration) and a feed-forward neural network layer 322 (also shown only in transformer block 304, for purposes of illustration). The transformer blocks 304, 306, and 308 are generally the same in structure, but (after training) will have different weights. In the multi-head attention layer 320, there are dependencies between the inputs to the transformer block, which may be used, for example, to provide context information for each input based on each other input to the transformer block. The feed-forward neural network layer 322 generally lacks these dependencies, so the inputs to the feed-forward neural network layer 322 may be processed in parallel. It will be understood that although only three transformer blocks (transformer blocks 304, 306, and 308) are shown in FIG. 2, in actual implementations of the disclosed technology, there may be many more such transformer blocks in the transformer stack 302. For example, some implementations may use 12 transformer blocks in the transformer stack 302.

Inputs 330 to the transformer stack 302 include tokens, such as a [CLS] token 332, and tokens 334. The tokens 334 may, for example represent words or portions of words. The [CLS] token 332 is used as a representation for classification for the entire set of tokens 334. Each of the tokens 334 and the [CLS] token 332 is represented by a vector. In some implementations, these vectors may each be, for example, 768 floating point values in length. It will be understood that a variety of compression techniques may be used to effectively reduce sizes (dimensionality) of the vectors. In some non-limiting embodiments of the present technology, there may be a fixed number of the tokens 334 that are used as the inputs 330 to the transformer stack 302. For example, in some non-limiting embodiments of the present technology, 1024 tokens may be used, while in other implementations, the transformer stack 302 may be configured to take 512 tokens (aside from the [CLS] token 332). Those of the inputs 330 that are shorter than this fixed number of tokens 334 may be extended to the fixed length by adding padding tokens, as an example.

In some implementations, the inputs 330 may be generated from a training digital object 336, such as at least one of a past digital document and a past query associated therewith, as will be described below, using a tokenizer 338. The architecture of the tokenizer 338 will generally depend on the training digital object 336 that serve as input to the tokenizer 338. For example, in some non-limiting embodiments of the present technology, the tokenizer 338 may involve use of known encoding techniques, such as byte-pair encoding, as well as use of pre-trained neural networks for generating the inputs 330.

However, in other non-limiting embodiments of the present technology, the tokenizer 338 can be implemented based on a WordPiece byte-pair encoding scheme, such as that used in BERT learning models with a sufficiently large vocabulary size. For example, in some non-limiting embodiments of the present technology, the vocabulary size may be approximately 120,000 tokens. In some non-limiting embodiments of the present technology, before applying the tokenizer 338, the inputs 330 can be preprocessed. For example, all words of the inputs 330 can be converted lowercase and Unicode NFC normalization can further be performed. The WordPiece byte-pair encoding scheme that may be used in some implementations to build the token vocabulary is described, for example, in Rico Sennrich et al., “Neural Machine Translation of Rare Words with Subword Units”, Proceedings of the 54th Annual Meeting of the Association for Computational Linguistics (Volume 1: Long Papers), pages 1715-1725, 2016.

Outputs 350 of the transformer stack 302 include a [CLS] output 352, and a vector of outputs 354, including a respective output value for each of the tokens 334 in the inputs 330 to the transformer stack 302. The outputs 350 may then be sent to a task module 370. In some implementations, as is depicted in FIG. 3, the task module 370 uses only the [CLS] output 352, which serves as a representation of the entire vector of the outputs 354. This can be most useful when the task module 370 is being used as a classifier, or to output a label or value that characterizes the entire input training digital object 336, such as generating a relevance score-for example, the respective likelihood value of the user 216 interacting with the given digital document described above. In some non-limiting embodiments of the present technology (not depicted in FIG. 3) all or some values of the vector of the outputs 354, and possibly the [CLS] output 352 may serve as inputs to the task module 370. This can be most useful when the task module 370 is being used to generate labels or values for each one of the tokens 334 of the inputs 330, such as for prediction of a masked or missing token or for named entity recognition. In some non-limiting embodiments of the present technology, the task module 370 may include a feed-forward neural network (not depicted) that generates a task-specific result 380, such as a relevance score or click probability. Other models could also be used in the task module 370. For example, the task module 370 may itself be a transformer or other form of neural network. Additionally, the task-specific result 380 may serve as an input to other models, such as a CatBoost model, as described in Dorogush et al., “CatBoost: gradient boosting with categorical features support”, NIPS 2017.

It will be understood that the architecture of the MLA 218 described above with reference to FIG. 3 has been simplified for ease of clarity and understanding of certain non-limiting embodiments of the present technology. For example, in an actual implementation of the MLA 218, each of the transformer blocks 304, 306, and 308 may also include layer normalization operations, the task module 370 may include a softmax normalization function, and so on. One of ordinary skill in the art would understand that these operations are commonly used in neural networks and deep learning models such as the MLA 218.

### Training Process

According to certain non-limiting embodiments of the present technology, the server 202 can be configured to retrieve training data and based thereon train the MLA 218 to determine the respective likelihood values of the user 216 interacting with each one of the set of digital documents 214.

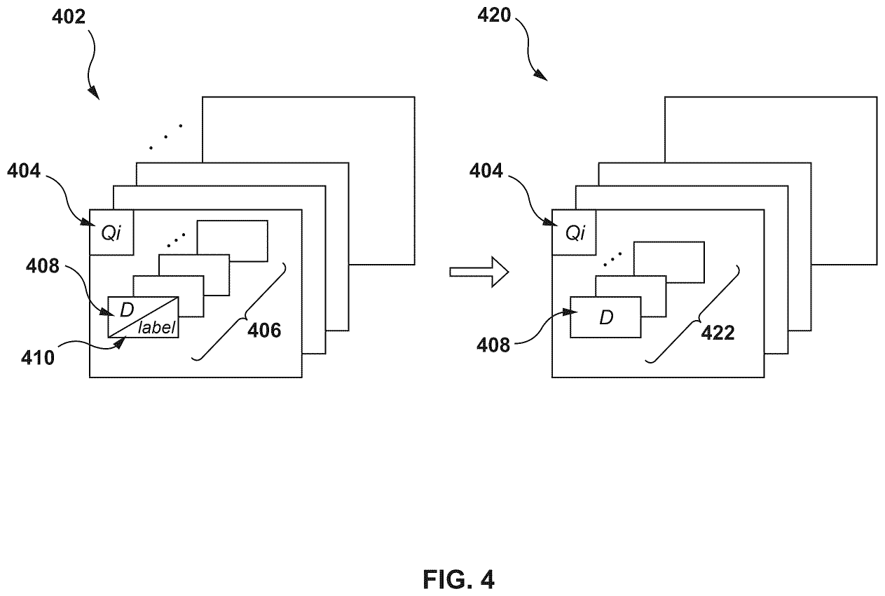

With reference to FIG. 4, there is depicted a schematic diagram of training data 402 associated with the user 216 and one of approaches of organizing it for training the MLA 218, in accordance with certain non-limiting embodiments of the present technology.

In some non-limiting embodiments of the present technology, the training data 402 can include data of past searches conducted by the user 216 using the online search platform 210. For example, the server 202 can be configured to retrieve, over the communication network 208, the data of past searches conducted by the user 216 from at least one electronic device associated therewith, such as the electronic device 204 described above. However, in other non-limiting embodiments of the present technology, the server 202 can be configured to retrieve the data of the past searches from the search database 206. Further, in some non-limiting embodiments of the present technology, the training data 402 can include data of a predetermined number of past searches the user 216 has conducted hitherto, such as 256 or 128, as an example. However, in other non-limiting embodiments of the present technology, the training data 402 can include data of the past searches the user 216 has conducted over a predetermined period, such as one month, one week, and the like.

More specifically, in some non-limiting embodiments of the present technology, the training data 402 can include a plurality of past queries submitted by the user 216 to the online search platform 210, such as a given past query 404. Further, for the given past query 404, the training data 402, can further include a respective set of past digital documents 406 generated by the online search platform 210 in response to receiving the given past query 404. Further, a given past digital document 408 of the respective set of past digital documents 406 includes a label 410 indicative of past user interaction of the user 216 with the given past digital document 408 upon receiving the respective set of past digital documents 406.

As noted hereinabove, the given past digital document 408 can include electronic media content entities of various formats and types that are suitable for being transmitted, received, stored, and displayed on the electronic device 204 using suitable software, such as a browser, as an example.

According to some non-limiting embodiments of the present technology, the past user interaction of the user 216 in respect of the given past digital document 408 may include at least one of: (i) a click of the user 216 on the given past digital document 408; (ii) a long click on the given past digital document 408, that is remaining in the given past digital document 408 after clicking thereon for a predetermined period (such as 120 seconds); (iii) dwelling on the given past digital document 408 over a predetermined period (such as 10 seconds), as an example.

Thus, the label 410 may take a binary value, such as one of ‘1’ (or ‘Positive’) if the user 216 has interacted with (such as clicked on) the given past digital documents 408, and ‘0’ (or ‘Negative’) if the user 216 has not interacted with the given past digital document 408 upon receiving the respective set of past digital documents 406.

In additional non-limiting embodiments of the present technology, the given past query 404 can further include query metadata (not depicted), such as a geographical region from which the user 216 submitted the given past query 404, and the like. Similarly, the given past digital document 408 can further include document metadata (not depicted), such as a title thereof, a web address thereof (for example, in the form of a URL), as an example.

Further, in some non-limiting embodiments of the present technology, the server 202 can be configured to train the MLA 218 to determine the respective likelihood values of the user 216 interacting with each one of the set of digital documents 214 described above in two phases. More specifically, during a first training phase, the server 202 can be configured to train the MLA 218 for determining if the user 216 has interacted with the given past digital document 408, that is for determining the value of the label 410 associated therewith. Further, during a second training phase, the server 202 can be configured to train the MLA 218 to determine respective likelihood values of the user 216 interacting with in-use digital documents, such as each one of the set of digital documents 214, while having access to weights generated in the first training phase. M ore specifically, during the first training phase, the server 202 can be said to determine initial weights of the transformer blocks 304, 306, and 308, as described above; and, during the second training phase, the server 202 can be configured to finetune the so determined initial weights of the transformer blocks 304, 306, and 308 of the MLA 218.

Thus, for training the MLA 218, for each one of the first and second training phase, the server 202 can be configured to organize the training data 402 in two different training sets of data as will be described below.

In some non-limiting embodiments of the present technology, for training the MLA 218 during the first training phase, the server 202 can be configured to organize the training data 402 in a first set of training digital objects 420, as further depicted in FIG. 4.

A given one of the first set of training digital objects 420 includes: (i) the given past query 404 and (ii) a first set of past digital documents 422. According to certain non-limiting embodiments of the present technology, each one of the first set of past digital documents 422 is selected from the respective set of past digital documents 406 having been generated by the online search platform 210 in response to the user 216 submitting the given past query 404, however, without data of respective labels associated therewith, such as the label 410 associated with the given past digital document 408. In other words, during the first training phase, the MLA 218 is not aware of the value of the label 410, and is trained for predicting it based on context provided by at least one of the given past digital document 408 associated therewith and the given past query 404.

It should be expressly understood that it is not limited how each one of the first set of past digital documents 422 has been selected from the respective set of past digital documents 406; and in some non-limiting embodiments of the present technology, the first set of past digital documents 422 may include all past digital documents of the respective set of past digital documents 406. However, in some non-limiting embodiments of the present technology, the first set of past digital documents 422 may include a predetermined number of past digital documents from the respective set of past digital documents 406, such as three, five, or twenty, as an example. In other non-limiting embodiments of the present technology, the server 202 can be configured to select each one of the predetermined number of training digital objects from the respective set of past digital documents 406 randomly, such as based on a predetermined distribution, such as normal, as an example. In yet other non-limiting embodiments of the present technology, the server 202 can be configured to select each one of the predetermined number of training digital objects from the respective set of past digital documents 406 as being positioned at preselected positions within the respective set of past digital documents 406, such as fifth, tenth, thirty-second, and the like.

Further, as noted above with reference to FIG. 3, using the tokenizer 338, the server 202 can be configured to convert the given one of the first set of training digital objects 420 in a respective token and feed it to the MLA 218 as part of the inputs 330 for training the MLA 218 to determine the values of the respective labels associated with each one of the first set of past digital documents 422 of the first set of training digital objects 420, that is, whether the user 216 has interacted therewith or not.

Thus, organization of the training data 402 in the first set of training digital objects 420 provides the MLA 218 with more tokens in the inputs 330, for which the MLA 218 is trained for generating respective value of the vector of outputs 354, thereby determining initial weights of the transformer blocks 304, 306, and 308. For example, the initial weights can be determined and further adjusted based on a difference or a distance between predicted values of the respective labels associated with each one of the first set of past digital documents 422 and ground truth, that is, actual values thereof obtained as part of the training data 402. For example, the server 202 can be configured to determine the difference using a loss function, such as a Cross-Entropy Loss function, as an example, and further adjust the initial weights of the transformer blocks 304, 306, and 308 to minimize the difference between the predicted and actual values of the respective labels.

It should be expressly understood that other implementations of the loss function are also envisioned by the non-limiting embodiments of the present technology and may include, by way of example, and not as a limitation, a Mean Squared Error Loss function, a Huber Loss function, a Hinge Loss function, and others.

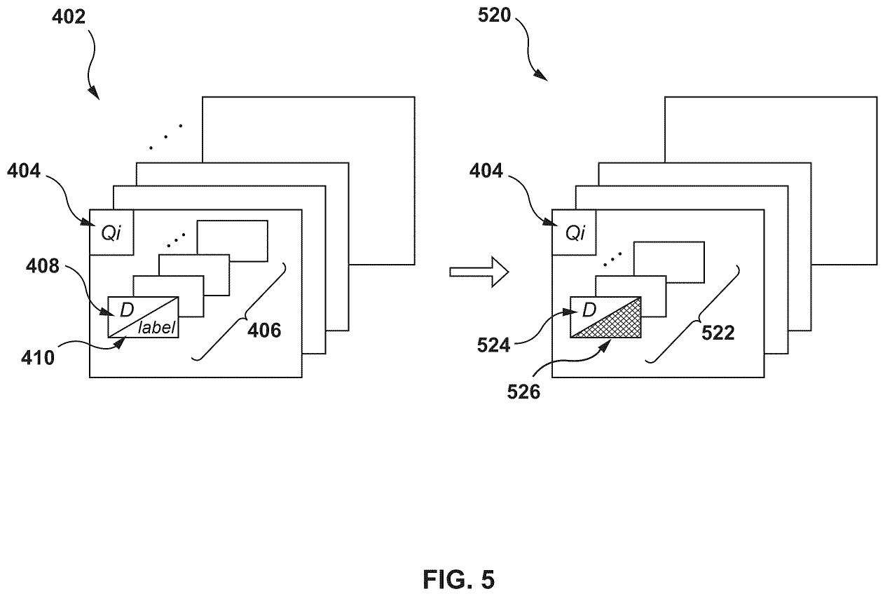

Further, with reference to FIG. 5, there is depicted a schematic diagram of the server 202 organizing the training data 402 into a second set of training digital objects 520 for training the MLA 218 during the second training phase, in accordance with certain non-limiting embodiments of the present technology.

According to certain non-limiting embodiments of the present technology, a given one of the second set of training digital objects 520 includes (i) the given past query 404 and (ii) a second set of past digital documents 522 having been selected, by the server 202, from the respective set of past digital documents 406. In some non-limiting embodiments of the present technology, the server 202 can be configured to select each one of the second set of past digital documents 522 as having a predetermined value of a respective user interaction therewith represented by associated labels, such as the value of the label 410 associated with the given past digital document 408. For example, in some non-limiting embodiment of the present technology, the server 202 can be configured to select only those from the respective set of past digital documents 406 that have positive values of the respective labels associated therewith for inclusion in the second set of past digital documents 522, such as a positive label 526 associated with an other given past digital document 524. In other words, in these embodiments, the server 202 can be configured to include only those past digital documents with which the user 216 has interacted-such as clicked thereon, as an example.

In some non-limiting embodiment of the present technology, a total number of training digital objects in the second set of training digital object 520 could be equal to that of the first set of training digital objects 420. However, in those embodiments of the present technology where the training data 402 includes respective sets of past digital documents where the user 216 did not interact with any one of past digital documents thereof, the total number of training digital objects in the second set of training digital objects 520 could be smaller than that of the first set of training digital objects 420.

In yet other non-limiting embodiments of the present technology, the total numbers in each one of the first set of training digital objects 420 and the second set of training digital objects 520 could be predetermined and comprise, for example, 100, 200, or 300 training digital objects as described above with reference to FIGS. 4 and 5, respectively.

Further, akin to the first training phase, the server 202 can be configured to convert each one of the second set of training digital objects 520 in a token using the tokenizer 338 and feed the so generated tokens to the MLA 218, thereby training the MLA 218 to determine likelihood values of the user 216 interacting with in-use digital documents, such as the set of digital documents 214 generated in response to the user 216 having submitted the given query 212.

Further, in some non-limiting embodiments of the present technology, the server 202 can be configured to use the so generated likelihood values of the user 216 interacting with the in-use digital documents and respective positive labels associated with each past digital document in the second set of training digital objects 520 to determine a difference therebetween using the loss function as described above. Further, the server 202 can be configured to minimize the difference, thereby adjusting the initial weights the transformer blocks 304, 306, and 308 determined in the first training phase.

Thus, with the so adjusted weights of the transformer blocks 304, 306, and 308, the server 202 can be configured to use the MLA 218 to determine the respective likelihood values of the user 216 interacting with the in-use digital documents, such as the set of digital documents 214 generated in response to the user 216 having submitted the given query 212 as described above with reference to FIG. 2.

### In-Use Process

According to certain non-limiting embodiments of the present technology, during the in-use process, the server 202 can be configured to receive the set of digital documents 214. Further, the server 202 can be configured to organize the set of digital documents 214 into a set of in-use digital objects, a given in-use digital object of which includes (i) the given query 212 and (ii) and a respective digital document of the set of digital documents 214. In additional non-limiting embodiments of the present technology, the given in-use digital objects may include metadata associated with the given query 212 and document metadata associated with each one of the set of digital documents 214, as described above.

Further, the server 202 can be configured to tokenize, such as by the tokenizer 338 described above, each one of the set of in-use digital objects and provide the resulting tokens as the inputs 330 to the MLA 218. Thus, based on the context provided by neighboring tokens in the inputs 330, the MLA 218 may be configured to predict, for a given token, a respective likelihood value of the user 216 interacting with a respective one of the set of digital documents 214 associated with the given token.

Further, the server 202 could be configured to use the so determined respective likelihood values for ranking the set of digital documents 214. To that end, in some non-limiting embodiments of the present technology, the server 202 can be configured to provide the respective likelihood values determined by the MLA 218 as an input to an other MLA (not depicted) that has been configured to rank digital documents based at least on associated respective likelihood values of a given user, such as the user 216, interacting therewith. In some non-limiting embodiments of the present technology, the other MLA can comprise an ensemble of CatBoost decision trees as mentioned above. The other MLA may thus generate a ranked set of digital documents.

Further, the server 202 can be configured to select an N-top digital documents from the ranked set of digital documents for transmitting indications thereof to the electronic device 204 of the user 216, such as within a respective client interface (not depicted) of the online search platform 210.

### Method

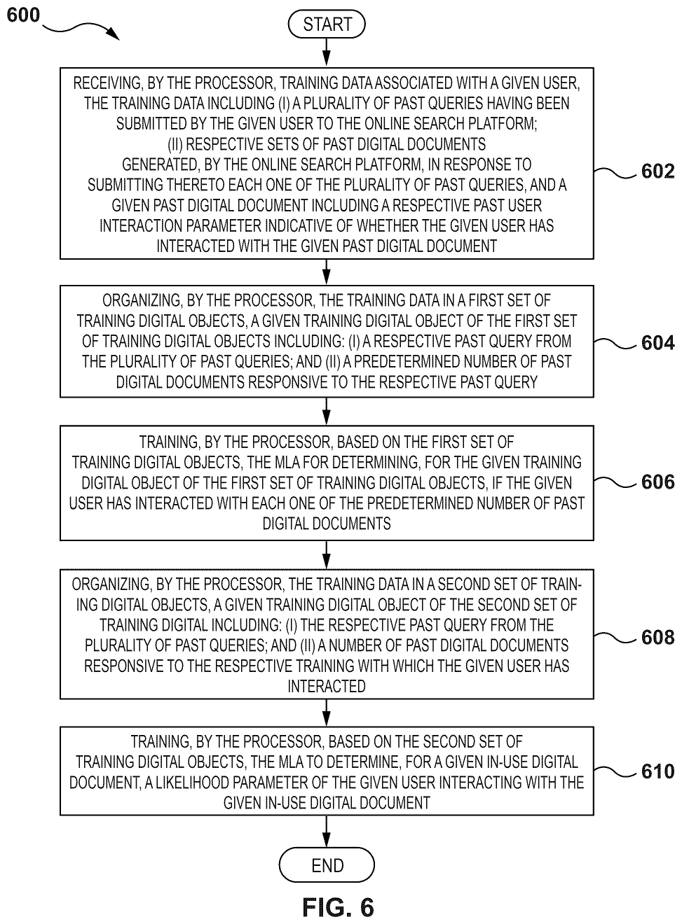

Given the architecture and the examples provided hereinabove, it is possible to execute a method for training an MLA to rank digital documents, such as the MLA 218 described above. With reference now to FIG. 6, there is depicted a flowchart diagram of a method 600, according to certain non-limiting embodiments of the present technology. The method 600 may be executed by the server 202.

STEP 602: RECEIVING, BY THE PROCESSOR, TRAINING DATA ASSOCIATED WITH A GIVEN USER, THE TRAINING DATA INCLUDING (I) A PLURALITY OF PAST QUERIES HAVING BEEN SUBMITTED BY THE GIVEN USER TO THE ONLINE SEARCH PLATFORM; (II) RESPECTIVE SETS OF PAST DIGITAL DOCUMENTS GENERATED, BY THE ONLINE SEARCH PLATFORM, IN RESPONSE TO SUBMITTING THERETO EACH ONE OF THE PLURALITY OF PAST QUERIES, AND A GIVEN PAST DIGITAL DOCUMENT INCLUDING A RESPECTIVE PAST USER INTERACTION PARAMETER INDICATIVE OF WHETHER THE GIVEN USER HAS INTERACTED WITH THE GIVEN PAST DIGITAL DOCUMENT

At step 602, according to certain non-limiting embodiments of the present technology, the server 202 could be configured to retrieve the training data 402 associated with the user 216 for training the MLA 218.

According to some non-limiting embodiments of the present technology, the MLA 218 may include a Transformer-based MLA, such as the BERT MLA, the architecture of which is described above with reference to FIG. 3.

As mentioned above with reference to FIG. 4, the training data 402 may include: (1) the plurality of past queries submitted by the user 216 to the online search platform 210; (2) respective sets of past digital documents, such as the respective set of past digital documents 406 generated by the online search platform 210 in response to receiving the given past query 404, wherein (3) the given past digital document 408 of the respective set of past digital documents 406 includes the label 410 indicative of past user interaction of the user 216 with the given past digital document 408 upon receiving the respective set of past digital documents 406.

In additional non-limiting embodiments of the present technology, the given past query 404 can further include query metadata (not depicted), such as a geographical region from which the user 216 submitted the given past query 404, and the like. Similarly, the given past digital document 408 can further include document metadata (not depicted), such as a title thereof, a web address thereof (for example, in the form of a URL), as an example.

For example, in some non-limiting embodiments of the present technology, the server 202 could be configured to retrieve the training data 402 from the electronic device 204 associated with the user 216 over the communication network 208. However, in other non-limiting embodiments of the present technology, the server 202 can be configured to retrieve the training data 402 from the search database 206 communicatively coupled thereto.

The method 600 thus proceeds to step 604.

STEP 604: ORGANIZING, BY THE PROCESSOR, THE TRAINING DATA IN A FIRST SET OF TRAINING DIGITAL OBJECTS, A GIVEN TRAINING DIGITAL OBJECT OF THE FIRST SET OF TRAINING DIGITAL OBJECTS INCLUDING: (I) A RESPECTIVE PAST QUERY FROM THE PLURALITY OF PAST QUERIES; AND (II) A PREDETERMINED NUMBER OF PAST DIGITAL DOCUMENTS RESPONSIVE TO THE RESPECTIVE PAST QUERY

Further, at step 604, the server 202 can be configured to organize the training data 402 into the first set of training digital objects 420 for training the MLA 218 during the first training phase for determining past user interactions of the user 216 with each past digital document of the training data 402, such as the given past digital document 408.

As noted above with reference to FIG. 4, the given one of the first set of training digital objects 420 includes: (i) the given past query 404 and (ii) the first set of past digital documents 422 having been selected from the respective set of past digital documents 406. Each one of the first set of past digital documents 422 is selected from the respective set of past digital documents 406, however, without data of respective labels associated therewith, such as the label 410 associated with the given past digital document 408.

The method 600 hence advances to step 606.

STEP 606: TRAINING, BY THE PROCESSOR, BASED ON THE FIRST SET OF TRAINING DIGITAL OBJECTS, THE MLA FOR DETERMINING, FOR THE GIVEN TRAINING DIGITAL OBJECT OF THE FIRST SET OF TRAINING DIGITAL OBJECTS, IF THE GIVEN USER HAS INTERACTED WITH EACH ONE OF THE PREDETERMINED NUMBER OF PAST DIGITAL DOCUMENTS

Thus, as described above with joint reference to FIGS. 3 and 4 using the first set of training digital objects 420, the server 202 can be configured to train the MLA 218 for determining the respective likelihood values of the user 216 interacting with each one of the first set of past digital documents 422 associated with the given one of the first set of training digital objects 420.

More specifically, the server 202 can be configured to convert the given one of the first set of training digital objects 420 in a respective token and feed it to the MLA 218 as part of the inputs 330 for training the MLA 218 for determining the values of the respective labels associated with each one of the first set of past digital documents 422 of the first set of training digital objects 420, that is, whether the user 216 has interacted therewith or not.

In other words, during the first training phase, the MLA 218 is not aware of the values of the respective labels associated with each one of the first set of past digital documents 422, and is trained for predicting them based on context provided by each of the past documents themselves as well as the given past query 404 used for generation thereof.

The method 600 hence proceeds to step 608.

STEP 608: ORGANIZING, BY THE PROCESSOR, THE TRAINING DATA IN A SECOND SET OF TRAINING DIGITAL OBJECTS, A GIVEN TRAINING DIGITAL OBJECT OF THE SECOND SET OF TRAINING DIGITAL INCLUDING: (1) THE RESPECTIVE PAST QUERY FROM THE PLURALITY OF PAST QUERIES; AND (II) A NUMBER OF PAST DIGITAL DOCUMENTS RESPONSIVE TO THE RESPECTIVE TRAINING WITH WHICH THE GIVEN USER HAS INTERACTED

At step 608, as described above with reference to FIG. 5, the server 202 can be configured to organize the training data 402 into the second set of training digital objects 520 for training the MLA 218 during the second training phase.

More specifically, as mentioned further above with reference to FIG. 5, the given one of the second set of training digital objects 520 includes (i) the given past query 404 and (ii) the second set of past digital documents 522 having been selected, by the server 202, from the respective set of past digital documents 406 as having positive values of the respective labels associated therewith.

The method 600 hence advances to step 610.

### STEP 610: TRAINING, BY THE PROCESSOR, BASED ON THE SECOND SET OF TRAINING DIGITAL OBJECTS, THE MLA TO DETERMINE, FOR A GIVEN IN-USE DIGITAL DOCUMENT, A LIKELIHOOD PARAMETER OF THE GIVEN USER INTERACTING WITH THE GIVEN IN-USE DIGITAL DOCUMENT

Thus, having generated the second set of training digital objects 520, the server 202 can be configured to train the MLA 218 to determine the respective likelihood values of the user 216 interacting with in-use digital documents, such as those of the set of digital documents 214, as described above with joint reference to FIGS. 3 and 5, similar to the first training phase.

Further, after the training the MLA 218, the server 202 can be configured to use it to determine the respective likelihood values of the user 216 interacting with each one of the set of digital documents 214 by organizing it into the in-use set of digital objects as described above and feed the in-use set of digital objects to the MLA 218.

Further, the server 202 can be configured to se the respective likelihood values for ranking each one of the set of digital objects 214. To that end, in some non-limiting embodiments of the present technology, the server 202 can be configured to provide the respective likelihood values determined by the MLA 218 as an input to the other MLA (not depicted) that has been configured to rank digital documents based at least on associated respective likelihood values of a given user, such as the user 216, interacting therewith. In some non-limiting embodiments of the present technology, the other MLA can comprise the ensemble of CatBoost decision trees as mentioned above.

Further, the server 202 can be configured to select an N-top digital documents from the ranked set of digital documents for transmitting indications thereof to the electronic device 204 of the user 216, such as within a respective client interface (not depicted) of the online search platform 210.

Thus, certain non-limiting embodiments of the method 600 allow improving quality of personalized ranking of digital documents.

The method 600 hence terminates.

It will also be understood that, although the embodiments presented herein have been described with reference to specific features and structures, various modifications and combinations may be made without departing from such disclosures. For example, various optimizations that have been applied to neural networks, including transformers and/or BERT may be similarly applied with the disclosed technology. Additionally, optimizations that speed up in-use relevance determinations may also be used. For example, in some implementations, the transformer model may be split, so that some of the transformer blocks are split between handling a query and handling a document, so the document representations may be pre-computed offline and stored in a document retrieval index. The specification and drawings are, accordingly, to be regarded simply as an illustration of the discussed implementations or embodiments and their principles as defined by the appended claims, and are contemplated to cover any and all modifications, variations, combinations or equivalents that fall within the scope of the present disclosure.

What is claimed is:

1. A computer-implemented method for training a machine-learning algorithm (MLA) to rank in-use digital documents at an online search platform, the MLA comprising a plurality of transformer blocks, and a given transformer block of the plurality of transformer blocks comprising:
a transformer encoder block,
a multi-head attention layer configured to determine dependencies between inputs to the given transformer block, and
a feed-forward neural network layer configured to: (i) receive outputs of the multi-head attention layer; and (ii) process the outputs of the multi-head attention layer in parallel,
the method being executable by at least one processor, the method comprising:
receiving, by the at least one processor, training data associated with a given user, the training data including (i) a plurality of past queries having been submitted by the given user to the online search platform; (ii) respective sets of past digital documents generated, by the online search platform, in response to submitting thereto each one of the plurality of past queries, and a given past digital document including a respective past user interaction parameter indicative of whether the given user has interacted with the given past digital document;
during a first training phase:
generating, by the at least one processor, using the training data, a first set of training digital objects, a given training digital object of the first set of training digital objects including: (i) a respective past query from the plurality of past queries; and (ii) a predetermined number of past digital documents responsive to the respective past query without including respective past user interaction parameters of the predetermined number of past digital documents;
applying, by the at least one processor, to the given training digital object of the first set of training digital object a tokenizer to generate a respective one of a first plurality of tokens;
feeding, by the at least one processor, the first plurality of tokens to the plurality of transformer blocks, thereby pre-training the MLA for determining, for the given training digital object of the first set of training digital objects, if the given user has interacted with each one of the predetermined number of past digital documents,
the pre-training comprising determining preliminary weights for the plurality of transformer blocks of the MLA;
during a second training phase, following the first training phase:
generating, by the at least one processor, using the training data, a second set of training digital objects, a given training digital object of the second set of training digital including: (i) the respective past query from the plurality of past queries; and (ii) a number of past digital documents responsive to the respective past query with which the given user has interacted with including the respective past user interaction parameters of the number of past digital documents;
applying, by the at least one processor, to the given training digital object of the second set of training digital object the tokenizer to generate a respective one of a second plurality of tokens; and
feeding, by the at least one processor, the second plurality of tokens to the plurality of transformer blocks, thereby finetuning the MLA to determine, for a given in-use digital document, a likelihood parameter of the given user interacting with the given in-use digital document,
the finetuning comprising adjusting the preliminary weights to determine adjusted weights of the plurality of transformer blocks of the MLA for further use in personalized ranking of in-use digital documents for the given user.

2. The method of claim 1, wherein the past digital documents associated with the given training digital objects of the first set of training digital objects have been randomly selected from a respective set of digital documents responsive to the respective past query.

3. The method of claim 1, wherein the respective past user interaction parameter associated with the given past digital document has been determined based on past click data of the given user.

4. The method of claim 3, wherein the click data includes data of at least one click of the given user on the given past digital document made in response to submitting the respective past query to the online search platform.

5. The method of claim 1, further comprising:
receiving, by the at least one processor, an in-use query;
retrieving, by the at least one processor, a set of in-use digital documents responsive to the in-use query;
applying, by the at least one processor, the MLA to each one of the set of in-use digital documents to generate respective likelihood parameters of the given user interacting therewith; and
using, by the at least one processor, the respective likelihood parameters for ranking each one of the set of in-use digital documents.

6. The method of claim 5, wherein the using the respective likelihood parameters comprises feeding, by the at least one processor, the respective likelihood parameters as an input to an other MLA, the other MLA having been configured to rank the set of in-use digital documents based at least on the respective likelihood values of the given user interacting therewith.

7. The method of claim 6, wherein the other MLA is an ensemble of CatBoost decision trees.

8. The method of claim 1, wherein the number of past digital documents responsive to the respective past query with which the given user has interacted are all the past digital documents in a respective set of digital documents responsive to the respective past query that the user has interacted with.

9. The method of claim 1, wherein a first total number of members in the first set of training digital objects and a second total number of members in the second set of training digital objects are the same.

10. The method of claim 1, wherein a first total number of members in the first set of training digital objects and a second total number of members in the second set of training digital objects are pre determined.

11. A system for training a machine-learning algorithm (MLA) to rank in-use digital documents at an online search platform, the MLA comprising a plurality of transformer blocks, and a given transformer block of the plurality of transformer blocks comprising:
a transformer encoder block,
a multi-head attention layer configured to determine dependencies between inputs to the given transformer block, and
a feed-forward neural network layer configured to: (i) receive outputs of the multi-head attention layer; and (ii) process the outputs of the multi-head attention layer in parallel,
the system comprising at least one processor and at least one non-transitory computer readable medium storing instructions, which, when executed by the at least one processor, cause the system to:
receive training data associated with a given user, the training data including (i) a plurality of past queries having been submitted by the given user to the online search platform; (ii) respective sets of past digital documents generated, by the online search platform, in response to submitting thereto each one of the plurality of past queries, and a given past digital document including a respective past user interaction parameter indicative of whether the given user has interacted with the given past digital document;
during a first training phase:
generate, using the training data, a first set of training digital objects, a given training digital object of the first set of training digital objects including: (i) a respective past query from the plurality of past queries; and (ii) a predetermined number of past digital documents responsive to the respective past query without including respective past user interaction parameters of the predetermined number of past digital documents;
apply to the given training digital object of the first set of training digital object a tokenizer to generate a respective one of a first plurality of tokens;
feed the first plurality of tokens to the plurality of transformer blocks, thereby pre-training the MLA for determining, for the given training digital object of the first set of training digital objects, if the given user has interacted with each one of the predetermined number of past digital documents, the pre-training comprising determining preliminary weights for the plurality of transformer blocks of the MLA;
during a second training phase, following the first training phase:
generate, using the training data, a second set of training digital objects, a given training digital object of the second set of training digital including: (i) the respective past query from the plurality of past queries; and (ii) a number of past digital documents responsive to the respective past query with which the given user has interacted with including the respective past user interaction parameters of the number of past digital documents;
apply to the given training digital object of the second set of training digital object the tokenizer to generate a respective one of a second plurality of tokens; and
feed the second plurality of tokens to the plurality of transformer blocks, thereby finetuning the MLA to determine, for a given in-use digital document, a likelihood parameter of the given user interacting with the given in-use digital document,
the finetuning comprising adjusting the preliminary weights to determine adjusted weights of the plurality of transformer blocks of the MLA for further use in personalized ranking of in-use digital documents for the given user.

12. The system of claim 11, wherein the at least one processor further causes the system to select the past digital documents associated with the given training digital objects of the first set of training digital objects from a respective set of digital documents responsive to the respective past query randomly.

13. The system of claim 11, wherein the at least one processor further causes the system to determine the respective past user interaction parameter associated with the given past digital document based on past click data of the given user.

14. The system of claim 13, wherein the click data includes data of at least one click of the given user on the given past digital document made in response to submitting the respective past query to the online search platform.

15. The system of claim 11, wherein the at least one processor further causes the system to:
receive an in-use query;
retrieve a set of in-use digital documents responsive to the in-use query;
apply the MLA to each one of the set of in-use digital documents to generate respective likelihood parameters of the given user interacting therewith; and
use the respective likelihood parameters for ranking each one of the set of in-use digital documents.

16. The system of claim 11, wherein the number of past digital documents responsive to the respective past query with which the given user has interacted are all the past digital documents in a respective set of digital documents responsive to the respective past query that the user has interacted with.

17. The system of claim 11, wherein a first total number of members in the first set of training digital objects and a second total number of members in the second set of training digital objects are the same.

18. The system of claim 11, wherein a first total number of members in the first set of training digital objects and a second total number of members in the second set of training digital objects are pre determined.
